(19) United States
(12) Patent Application Publication
(10) Pub. No.: US 2026/0167824 A1
(43) Pub. Date: Jun. 18, 2026

(54) Composition for high-resilient thermally conductive gap pad

(71) Applicant: Henkel AG & Co. KGaA, Duesseldorf (DE)

(72) Inventors: JianYing Chen, Shanghai (CN); WenTing Gao, Shanghai (CN); HaiYang Liu, Shanghai (CN); Dannie Dan Xie, Shanghai (CN)

(21) Appl. No.: 19/385,584

(22) Filed: Nov. 11, 2025

Related U.S. Application Data
(63) Continuation of application No. PCT/CN2023/095004, filed on May 18, 2023.

(51) Int. Cl. C08L 83/04; C08K 3/013; C08K 9/06

(52) U.S. Cl. CPC C08L 83/04; C08K 3/013; C08K 9/06; C08K 2201/001; C08K 2201/005

(57) ABSTRACT

The present invention relates to a composition for a high-resilient thermally conductive gap pad, to a gap pad made from said composition, as well as to a method of preparing a gap pad with said composition.

### TECHNICAL FIELD

The present invention relates to a composition for a high-resilient thermally conductive gap pad, to a gap pad made from said composition, as well as to a method of preparing a gap pad with said composition.

### BACKGROUND OF THE INVENTION

With the development of the artificial intelligence industry and 5G technology, more and more devices used therein generate very large amount of heat and require high resilience between connections. The thermally conductive gap pad is widely used in various electronic products (such as wireless device RRU and BBU for base station), heating elements (power tubes, thyristors, electric heating piles, etc.) and heat dissipation facilities (heat sinks, heat sinks, shells, etc.) in electrical equipment, so as to ensure the heat dissipation and shock-proof.

The greater the thermal conductivity, the faster the thermally conductive gap pad can absorb and dissipate heat. The resilience of the thermally conductive gap pad determines whether the thermally conductive gap pad can fill the gap between the heating part and the heat dissipation part, and can seal the gap. A good thermally conductive gap pad should have good thermal conductivity and good resilience, so as to ensure that the thermally conductive gap pad can seal the gap and have a better thermal conductivity to complete the heat transfer between the heating part and the heat dissipation part.

It is known in the art that the fillers determine the thermal conductivity of the gap pad. For example, JP2003301189 A, JP201013563A and US20180134938A1 teach how to improve the thermally conductivity by using different kinds of fillers.

In order to improve the resilience of the gap pad, many approaches have been studied, such as improving the proportion of the silicone oil(s) in the composition, introducing a toughener polymer in liquid or dissolved state that can cross-link with the silicone oil(s) and/or form a part of the cured network polymer. However, too much amount of the silicone oil(s) would affect the thermal conductivity of the gap pad, thus, the fillers and the silicone oil(s) have to be balanced so as to achieve a balance of the thermal conductivity and the resilience. Adding the polymer in liquid or dissolved state to cross-link with the silicone oil(s) would cause a complex curing process.

There is a need to optimize the organic phase of the composition for the thermally conductive gap pad so as to further improve the pad's resilience while do not do harm to the thermal conductivity.

### SUMMARY OF THE INVENTION

After intensive study, the inventors of the present application have found that, by introducing a specific core-shell solid polymer particle that does not cross-link with the silicone oil(s), the resilience of the obtained gap pad can be greatly improved, while the thermal conductivity is not negatively affected, even slightly improved. Especially, the above effects can be achieved with only a small amount of said solid polymer.

In one aspect, the present application provides a composition for a high-resilient thermally conductive gap pad, comprising, or consisting of:
(a) a reactive silicone oil,
(b) a silane coupling agent,
(c) a catalyst,
(d) optionally, an inhibitor,
(e) a thermal conductive filler, and
(f) a core-shell solid polymer particle, wherein the core-shell solid polymer particle has a soft core formed by a polymer having a Tg of less than 0° C. and a hard shell formed by a polymer having a Tg of no less than 0° C.

In another aspect, the present application provides a thermally conductive gap pad made from the composition of the first aspect.

In still another aspect, the present application provides a method for preparing the thermally conductive gap pad with the composition of the first aspect, said method comprising:
(i) mixing the following components (a) to (f) to form a mixture:
   (a) a reactive silicone oil,
   (b) a silane coupling agent,
   (c) a catalyst,
   (d) optionally, an inhibitor,
   (e) a thermal conductive filler, and
   (f) a core-shell solid polymer particle, wherein the core-shell solid polymer particle has a soft core formed by a polymer having a Tg of less than 0° C. and a hard shell formed by a polymer having a Tg of no less than 0° C.,
(ii) allowing the mixture to cure.

The advantages of the present invention include:
(1) The specific solid core-shell polymer particle (especially only small amount of which) can greatly improve the resilience of the obtained gap pad, without compromising the thermal conductivity, even slightly improving the thermal conductivity, and
(2) Compared with the known approaches in the art, the composition of the present invention contains relatively small amount of the silicone oil(s).

### BRIEF DESCRIPTION OF DRAWINGS

FIGS. 1A to 1B are FTIR spectrums of a core-shell particle and cured silicone oils with the core-shell particle contained therein.

FIG. 2 are photos of a composition comprising a polyether ester elastomer and cured product thereof, and a composition comprising a core-shell polymer particle and cured product thereof.

### DETAILED DESCRIPTION OF THE INVENTION

It is to be understood by one of ordinary skill in the art that the present discussion is a description of exemplary embodiments only and is not intended as limiting the broader aspects of the present invention. Each aspect so described may be combined with any other aspect(s) unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, all wt. % or % by weight values quoted herein are percentages by weight.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “consisting essentially of” as used herein means that the listed components constitute main body of the composition, for example, at least 80% by weight of the composition, at least 85% by weight of the composition, or at least 90% by weight of the composition.

The term “consisting of” as used herein is close-ended and exclude additional, non-recited intentional members, elements or process steps.

The term “at least one” or “one or more” used herein to define a component refers to the type of the component, and not to the absolute number of molecules. For example, “one or more monomers” means one type of monomer or a mixture of a plurality of different monomers.

The terms “about”, “around” and the like used herein in connection with a numerical value refer to the numerical value ±10%, preferably ±5%. All numerical values herein should be interpreted as being modified by the term “about”.

Unless specified otherwise, the recitation of numerical end points includes all numbers and fractions subsumed within the respective ranges, as well as the recited end points.

All references cited in the present specification are hereby incorporated by reference in their entirety.

Unless otherwise defined, all terms used in the present invention, including technical and scientific terms, have the meaning as commonly understood by one of the ordinary skilled in the art to which this invention belongs.

Hereinafter the composition for a high-resilient thermally conductive gap pad will be described in detail.

The composition for a high-resilient thermally conductive gap pad comprises or consists of:
(a) a reactive silicone oil,
(b) a silane coupling agent,
(c) a catalyst,
(d) optionally, an inhibitor,
(e) a thermal conductive filler, and
(f) a core-shell solid polymer particle, wherein the core-shell solid polymer particle has a soft core formed by a polymer having a Tg of less than 0° C. and a hard shell formed by a polymer having a Tg of no less than 0° C.

### Component (a): Reactive Silicone Oil

The silicone oil used herein also is called organopolysiloxane. In the present application, the reactive silicone oil refers to an organopolysiloxane carrying a reactive group that can react with a silane coupling agent and/or with another organopolysiloxane carrying a reactive group. For example, the reactive group can be a —SiH group and/or an alkenyl group.

The reactive silicone oil used herein comprises or consists essentially of or consists of terminal group (R)₃SiO_{1/2} (M unit) and at least one middle group selected from (R)₂SiO_{2/2} (D unit), RSiO_{3/2} (T unit) and SiO_{4/2} (Q unit), wherein R, independently from each other, represents a mono-valent hydrocarbon group having 1 to 40 carbon atoms, with the proviso that at least one of the M unit, D unit and T unit comprises a reactive group selected from —SiH group and the alkenyl group. In other words, at least one R group in the silicone oil is a reactive group. Preferably, at least two R groups in the silicone oil are reactive groups.

As used herein, “alkenyl” refers to a radical of a straight-chain or branched hydrocarbon group having from 2 to 40 carbon atoms and one or more carbon-carbon double bonds (e.g., 1, 2, 3, or 4 double bonds) (“C₂₋₄₀ alkenyl”). In some embodiments, an alkenyl group has 2 to 30 carbon atoms (“C₂₋₃₀ alkenyl”). In some embodiments, an alkenyl group has 2 to 20 carbon atoms (“C₂₋₂₀ alkenyl”). In some embodiments, an alkenyl group has 2 to 10 carbon atoms (“C₂₋₁₀ alkenyl”). In some embodiments, an alkenyl group has 2 to 9 carbon atoms (“C₂₋₉ alkenyl”). In some embodiments, an alkenyl group has 2 to 8 carbon atoms (“C₂₋₈ alkenyl”). In some embodiments, an alkenyl group has 2 to 7 carbon atoms (“C₂₋₇ alkenyl”). In some embodiments, an alkenyl group has 2 to 6 carbon atoms (“C₂₋₆ alkenyl”). In some embodiments, an alkenyl group has 2 to 5 carbon atoms (“C₂₋₅ alkenyl”). In some embodiments, an alkenyl group has 2 to 4 carbon atoms (“C₂₋₄ alkenyl”). In some embodiments, an alkenyl group has 2 to 3 carbon atoms (“C₂₋₃ alkenyl”). In some embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (C₈), octatrienyl (C₈), and the like. Unless otherwise specified, each instance of an alkenyl group is independently unsubstituted (an “unsubstituted alkenyl”) or substituted (a “substituted alkenyl”) with one or more substituents. In certain embodiments, the alkenyl group is an unsubstituted C₂₋₃₀ alkenyl. In certain embodiments, the alkenyl group is a substituted C₂₋₃₀ alkenyl.

When the group R in the M, D, T units does not represent a reactive group, it preferably represents C₁-C₃₀ linear alkyl groups, preferably selected from methyl group, ethyl group, n-propyl group, n-butyl group, n-pentyl group, n-hexyl group, n-heptyl group, n-octyl group, n-nonyl group, n-decyl group, n-undecyl group, n-dodecyl group, ntridecyl group, n-tetradecyl group, n-pentadecyl group, n-hexadecyl group, n-heptadecyl group, noctadecyl group, n-nonadecyl group, and n-eicosyl group; C₁-C₃₀ branched alkyl groups, preferably selected from isopropyl group, t-butyl group, isobutyl group, 2-methylundecyl group, and 1-hexylheptyl group; C₃-C₂₀ cyclic alkyl groups, preferably selected from a cyclopentyl group, cyclohexyl group, and cyclododecyl group; C₆-C₂₀ aryl groups, preferably selected from a phenyl group, tolyl group, and xylyl group; C₇-C₂₀ aralkyl groups, preferably selected from a benzyl group, phenethyl group, and 2-(2,4,6-trimethylphenyl) propyl group; and halogenated C₁-C₃₀ alkyl groups, preferably selected from 3,3,3-trifluoropropyl group and 3-chloropropyl group.

As for a unit comprising an alkenyl group, it is abbreviated as M^{vi}, D^{vi}, T^{vi}.

In some embodiments, the reactive silicone oils useful in the present application can be M^{vi}D, that is, consisting of terminal unit (R)₃SiO_{1/2} wherein at least one R is an alkenyl group and middle unit (R)₂SiO_{2/2}, in which remaining R groups have the same meanings as defined above. In some embodiments, the reactive silicone oils useful in the present application can be M^{vi}DM, M^{vi}DM^{vi}, MD^{vi}M, M^{vi}D^{vi}M, MTM^{vi}, M^{vi}TM^{vi}, MT^{vi}M, M^{vi}T^{vi}M, MQM^{vi}, M^{vi}QM^{vi}, M^{vi}DTM, MD^{vi}TM, MDT^{vi}M, M^{vi}D^{vi}TM, M^{vi}DT^{vi}M, M^{vi}DTM^{vi}, MD^{vi}T^{vi}M, M^{vi}DTQM, MD^{vi}TQM, MDT^{vi}QM, M^{vi}D^{vi}TQM, M^{vi}DT^{vi}QM, M^{vi}DTQM^{vi}, MD^{vi}T^{vi}QM, in which non-reactive R groups have the same meanings as defined above.

As for an alkenyl-containing silicone oil, it is preferably that the alkenyl group is a vinyl group. Specific examples of the vinyl-containing silicone oil include the compounds represented by the general formulas (i) to (v) shown as below.

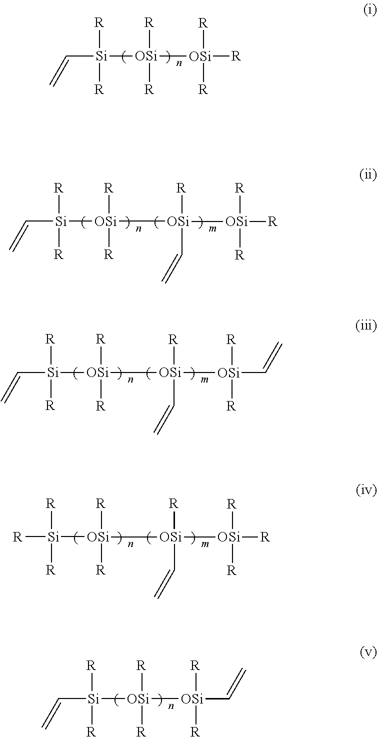

In the formulas (i) to (v) above, R, independently from each other, has the same meanings defined above, and is preferably a methyl group or a phenyl group.

In the formulas (i) to (v) above, n independently is an integer of from 0 to 5000, such as 0, 10, 50, 100, 200, 500, 1000, 1500, 2000, 2500, 3000, 3500, 4000, 4500, or any ranges between two above-listed values; m (if present) independently is an integer of from 1 to 5000, such as 2, 3, 4, 5, 6, 7, 8, 9, 10, 50, 100, 200, 500, 1000, 1500, 2000, 2500, 3000, 3500, 4000, 4500, or any ranges between two above-listed values; n+m (if present) ranges from 5 to 10000, such as 6, 10, 50, 100, 200, 500, 1000, 1500, 2000, 2500, 3000, 3500, 4000, 4500, 5000, 5500, 6000, 6500, 7000, 7500, 8000, 8500, 9000, 9500 or any ranges between two above-listed values.

Preferably, specific examples of the alkenyl-containing silicone oil include but not limited to dimethylvinylsilyl-terminated dimethylpolysiloxane, trimethylsilyl-terminated (methylvinyl)(dimethyl) polysiloxane, dimethylvinylsilyl-terminated (methylvinyl) (dimethyl) polysiloxane, and cyclic methylvinylpolysiloxane.

Preferably, the content of the vinyl group in the vinyl-containing silicone oil is 0.05 wt % to 3.0 wt %, for example, 0.08, 0.1, 0.15, 0.20, 0.25, 0.3, 0.35, 0.4, 0.45, 0.5, 0.55, 0.6, 0.65, 0.7, 0.75, 0.8, 0.9, 1.0, 1.2, 1.4, 1.6, 1.8, 2.0, 2.2, 2.4, 2.6, 2.8 wt %, or any ranges between two numbers listed above.

In some embodiments, the alkenyl-containing silicone oils may have a viscosity in the range of 50 mPa·s to 200,000 mPa·s, and preferably in the range of from 60 mPa·s to 150,000 mPa·s, for example, 80, 100, 120, 150, 170, 200, 130, 250, 280, 300, 350, 400, 450, 500, 550, 600, 650, 700, 750, 800, 850, 900, 950, 1000, 1100, 1200, 1300, 1400, 1500, 1600, 1700, 1800, 1900, 2000, 2100, 2200, 2300, 2400, 2500, 2600, 2700, 2800, 2900, 3000, 3200, 3400, 3600, 3800, 4000, 4500, 5000, 5500, 6000, 6500, 7000, 7500, 8000, 8500, 9000, 9500, 10000, 11000, 12000, 13000, 14000, 15000, 16000, 18000, 20000, 30000, 40000, 50000, 60000, 70000, 80000, 90000, 100000, 110000, 120000, 130000, 140000, 150000, 160000, 170000, 180000, 190000 mPa·s, or any ranges between two numbers listed above. The viscosity in the present application, unless stated otherwise, is determined under 25° C. using Brookfield viscometer according to known method.

As for a unit comprising a —SiH group, it is abbreviated as M^{SiH}, D^{SiH}, T^{SiH}

In some embodiments, the SiH-containing silicone oils useful in the present application can be M^{SiH}D, that is, consisting of terminal unit (R)₃SiO_{1/2} wherein at least one R is hydrogen atom and middle unit (R)₂SiO_{2/2}, in which remaining R groups have the same meanings as defined above. In some embodiments, the reactive silicone oils useful in the present application can be M^{SiH}DM, M^{SiH}DM^{SiH}, MD^{SiH}M, M^{SiH}D^{SiH}M, MTM^{SiH}, M^{SiH}TM^{SiH}, MT^{SiH}M, M^{SiH}T^{SiH}M, MQM^{SiH}, M^{SiH}QM^{SiH}, M^{SiH}DTM, MD^{SiH}TM, MDT^{SiH}M, M^{SiH}D^{SiH}TM, M^{SiH}DT^{SiH}M, M^{SiH}DTM^{SiH}, MD^{SiH}T^{SiH}M, M^{SiH}DTQM, MD^{SiH}TQM, MDT^{SiH}QM, M^{SiH}D^{SiH}TQM, M^{SiH}DT^{SiH}QM, M^{SiH}DTQM^{SiH}, MD^{SiH}T^{SiH}QM, in which non-reactive R groups have the same meanings as defined above.

Specific examples of the SiH-containing silicone oil include but not limited to the compounds represented by the general formulas (vi) shown as below.

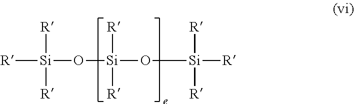

In the above formula (vi), at least one of R's represents hydrogen atom, or at least two of R's represent hydrogen atom, the remaining R's have the same meaning as those defined for the group R above, and index e represents an integer of 1 or more, such as 2, 4, 6, 8, 10, 12, 14, 16, 18, 20, 22, 24, 26, 28, 30, 40, 50, 60, 70, 80, 90, 100, 120, 140, 160, 180, 200, 220, 240, 260, 280, 300, 320, 340, 360, 380, 400, 420, 440, 460, 480, 500.

Preferably, specific examples of the SiH-containing silicone oil include but not limited to dimethylhydrosilyl-terminated dimethylpolysiloxane, trimethylsilyl-terminated (methylhydro)(dimethyl) polysiloxane, dimethylhydrosilyl-terminated (methylhydro) (dimethyl) polysiloxane, and cyclic methylhydropolysiloxane.

Preferably, the active hydrogen content in the SiH-containing silicone oil is 0.01 to 2.0 wt %, for example, 0.02, 0.04, 0.06, 0.08, 0.10, 0.12, 0.14, 0.15, 0.16, 0.18, 0.20, 0.22, 0.24, 0.25, 0.26, 0.28, 0.30, 0.32, 0.35, 0.4, 0.45, 0.5, 0.55, 0.6, 0.65, 0.7, 0.75, 0.8, 0.9, 1.0, 1.2, 1.4, 1.6, 1.8, 2.0 wt %, or any ranges between two numbers listed above. As used herein, the term “active hydrogen” means the hydrogen atom in the —SiH group.

In some embodiments, the SiH-containing silicone oils may have a viscosity in the range of 10 mPa·s to 2,000 mPa·s, and preferably in the range of from 20 mPa·s to 1,500 mPa·s, for example, 30, 40, 50, 60, 70, 80, 90, 100, 110, 120, 130, 140, 150, 160, 170, 200, 130, 250, 280, 300, 350, 400, 450, 500, 550, 600, 650, 700, 750, 800, 850, 900, 950, 1000, 1100, 1200, 1300, 1400, 1500, 1600, 1700, 1800, 1900 mPa·s, or any ranges between two points listed above. The viscosity in the present application, unless stated otherwise, is determined under 25° C. using Brookfield viscometer according to known method.

In some embodiments, the component (a) comprises or consists of only one type of alkenyl-containing silicone oil. In some embodiments, the component (a) comprises or consists of a mixture of an alkenyl-containing silicone oil and a SiH-containing silicone oil, or a mixture of different alkenyl-containing silicone oils, or a mixture of different SiH-containing silicone oils. Preferably, the component (a) comprises or consists of a mixture of an alkenyl-containing silicone oil and a SiH-containing silicone oil.

The reactions among the alkenyl-containing silicone oil, the SiH-containing silicone oil and a silane coupling agent are known in the art, and the reactions may form a polymer network imparting resilience to the cured product. For example, the alkenyl group may react with the SiH group through hydrosilylation mechanism in the presence of a catalyst; two alkenyl groups may react with a silane coupling agent, so as to be linked together; two SiH groups may react with a silane coupling agent, so as to be linked together; and the alkenyl group and the SiH group may react with a silane coupling agent, so as to be linked together.

Examples of commercially available products of the alkenyl-containing silicone oil include RH-vi series, like RH-Vi100E, RH-Vi322, RH-Vi323 and RH-Vi324 available from Zhejiang Runhe Chemical New Material Co., Ltd.

Examples of commercially available products of the SiH-containing silicone oil include RH-LHC-3, RH-H series, RH-DH series, RH-222-4, RH-222-10, RH-222-3, available from Zhejiang Runhe Chemical New Material Co., Ltd.

The component (a) may be comprised in the composition in an amount of 1.0 to 7.0 wt %, or 2.0 to 6.8 wt %, such as 1.5, 2.0, 2.5, 3.0, 3.5, 4.0, 4.4, 4.6, 4.8, 5.0, 5.2, 5.4, 5.6, 5.8, 6.0, 6.2, 6.4, 6.6 wt %, or any ranges between two numbers listed above, based on total weight of the composition.

When the composition (a) comprises a mixture of the alkenyl-containing silicone oil and the SiH-containing silicone oil, the ratio between the alkenyl-containing silicone oil and the SiH-containing silicone oil are not particularly limited, for example, in a molar ratio of 1:0.01 to 0.01:1, such as 1:0.02, 1:0.04, 1:0.06, 1:0.08, 1:0.1, 1:0.2, 1:0.4, 1:0.6, 1:0.8, 1:1, 0.02:1, 0.04:1, 0.06:1, 0.08:1, 0.1:1, 0.2:1, 0.4:1, 0.6:1, 0.8:1.

### Component (b): Silane Coupling Agent

The composition comprises a silane coupling agent which can react with the alkenyl-containing silicone oils and/or the SiH-containing silicone oils.

The silane coupling agents that are conventionally used in the art can be used in the present application without particular limitations.

Suitable silane coupling agents that can be used in the present application, include but not limited to, 3-methacryloxypropyltrimethoxysilane, methyltrimethoxysilane, 3-glycidoxypropyltrimethoxysilane, tetraethoxysilane, vinyltriethoxysilane, methyltris(methylethylketoxime)silane, vinyltriacetoxysilane, ethyl orthosilicate and the like.

Examples of commercially available examples of the silane coupling agent include 3-methacryloxypropyltrimethoxysilane, methyltrimethoxysilane, 3-glycidoxypropyltrimethoxysilane from Sinopharm and 9116 from Evonik.

According to the present invention, the silane coupling agent may be contained in the composition in an amount of from 0.1% to 5.0% by weight, preferably from 0.1% to 3% by weight, such as, 0.2, 0.3, 0.4, 0.5, 0.6, 0.7, 0.8, 1.0, 1.2, 1.4, 1.6, 1.8, 2.0, 2.5, 3.0, 3.5, 4.0, 4.5 wt %, or any ranges between two numbers listed above, based on the total weight of composition.

### Component (c): Catalyst

In the composition of the present application, an effective amount of the catalyst for catalysing the hydrosilylation between the alkenyl group and —SiH group may be contained.

Catalysts suitable for the present application include platinum group metal-based catalysts, which are known in the art. The platinum group metal includes platinum, ruthenium, rhodium, palladium, osmium and iridium. Preferably, catalysts using platinum or its compounds are selected. Specific examples thereof include platinum (including platinum black), rhodium, and palladium; platinum chloride, chloroplatinic acid and chloroplatinate such as H₂PtCl₄·nH₂O, H₂PtCl₆·nH₂O, NaHPtCl₆·nH₂O, KHPtCl₆·nH₂O, Na₂PtCl₆·H₂O, K₂PtCl₄·nH₂O, PtCl₄·nH₂O, PtCl₂, and Na₂HPtCl₄·nH₂O (here, in the formula, n is an integer of 0 to 6, preferably alcohol-modified chloroplatinic acid); complexes of chloroplatinic acid and olefin; ones obtained by supporting a platinum group metal such as platinum black and palladium on a support such as alumina, silica or carbon; a rhodium-olefin complex, chlorotris (triphenylphosphine) rhodium (Wilkinson catalyst); and, complexes of platinum chloride, chloroplatinic acid or chloroplatinate and a vinyl group-containing siloxane, in particular, a vinyl group-containing cyclic siloxane may be used.

Suitable commercially available examples of catalysts include CATALYST 512 from Evonik and CAT-50 available from Avantor.

The effective amount of the catalyst is known for the skilled person in the art or can be determined by the skilled person in the art according to the reactants used. According to the present invention, the catalyst is preferably present in an amount of from 0.001 to 0.05 wt %, preferably from 0.002 to 0.03 wt %, such as 0.004, 0.006, 0.008, 0.01, 0.015, 0.02, 0.025 wt %, or any ranges between two numbers listed above, based on the total weight of the composition.

### Component (d): Inhibitor

Hydrosilylation with catalyst has fast reaction kinetics. In order to satisfy the requirements of preparation, transportation, storage or formulation time, hydrosilylation inhibitors are usually added.

Alkynol type curing inhibitors and other inhibitors that are conventionally used in the art can be used in the present application.

Specific examples of the inhibitors include alkynols such as 3-butyn-2-ol, 1-pentyn-3-ol, 1-hexyn-3-ol, 1-heptyn-3-ol, 5-methyl-1-hexyn-3-ol, 3,5-dimethyl-1-hexyn-3-ol, 1-ethynyl-1-cyclopentanol, 1-ethynyl-1-cyclohexanol, 1-ethynyl-1-cycloheptanol, 3-ethyl-1-hexyn-3-ol, 3-ethyl-1-heptyn-3-ol, 3-isobutyl-5-methyl-1-hexyn-3-ol, 3,4,4-trimethyl-1-pentyn-3-ol, 3-ethyl-5-methyl-1-heptyn-3-ol, 4-ethyl-1-octyn-3-ol, 3,7,11-trimethyl-1-dodecyn-3-ol, 1-ethynyl-1-cyclooctanol, 3-methyl-1-octyn-3-ol, 3-methyl-1-nonyn-3-ol, 3-methyl-1-decyn-3-ol, 3-methyl-1-dodecyn-3-ol, 3-ethyl-1-pentyn-3-ol; a hydrazine-based compound; a phosphine-based compound; multi-vinylpolysiloxanes or a mercaptan-based compound.

Suitable commercially available examples of the inhibitor include Inhibitor MVC from Evonik and 3,5-dimethyl-1-hexyn-3-ol from Sigma-Aldrich Company.

In the present application, when the requirements of preparation, transportation, storage or formulation time can be satisfied without adding the inhibitor, the inhibitor can be omitted.

When the inhibitor is present in the composition of the present application, the amount thereof can be adjusted by the skilled person in the art according to requirements without particular limitation. For example, an amount of 0.0001 to 1.0 wt %, preferable 0.001 to 0.5 wt %, such as 0.01, 0.02, 0.03, 0.04, 0.05, 0.07, 0.09, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95 wt %, or any ranges between two numbers listed above, of the inhibitor can be contained in the composition of the present application, based on the total weight of the composition.

### Component (e): Thermally Conductive Filler

Thermally conductive fillers that are conventionally used in the art can be used in the composition of the present application. Examples of the fillers include, but not limited to, diamond particles, alumina particles, aluminium nitride particles, fumed silica, precipitated silica, fumed titanium oxide and combinations thereof.

It is preferred if the surface of the fillers of the present application is treated, for example, by a compound that is easy to be blended with the silicone oil matrix. The purpose of the surface treatment is to improve the dispersibility of the fillers in the silicone oil matrix. For example, the surface of the fillers can be treated with a surface treating agent such as a silane compound, an organotitanium compound, an organoaluminium compound or a phosphate compound, and preferably with the silane compound.

In the context, the term “diamond” or “diamond particle” or “aluminium nitride” or “aluminium oxide” or “fumed silica” or “precipitated silica” or “fumed titanium oxide” includes both non-surface-treated and surface-treated forms.

The fillers suitable for the present application preferably have a D₅₀ particle size of at least 0.01 μm but no greater than 200 μm, for example, 1, 2, 3, 5, 7, 8, 10, 20, 30, 40, 50, 60, 70, 80, 90, 100, 110, 120, 130, 140, 150, 160, 170, 180 and 190 μm, or any ranges between the above two numbers.

Herein, the term “D₅₀ particle size” means a median diameter in a volume-basis particle size distribution curve obtained by measurement with a laser diffraction particle size analyzer.

Preferably, the fillers with different particle sizes are mixed together as the component (e), that is, a big particle and a small particle are mixed together. For example, a big particle with a D₅₀ particle size of at least 100 μm (such as 100-200 μm, 100-150 μm) and a small particle with a D₅₀ particle size of less than 100 μm (such as 0.1-less than 100 μm, 1-50 μm, 1-30 μm) are mixed together as the component (e); a big particle with a D₅₀ particle size of at least 50 μm (such as 50-200 μm, 50-150 μm) and a small particle with a D₅₀ particle size of less than 50 μm (such as 0.1-less than 50 μm, 1-30 μm, 1-20 μm) are mixed together as the component (e); a big particle with a D₅₀ particle size of at least 30 μm (such as 30-200 μm, 30-150 μm) and a small particle with a D₅₀ particle size of less than 30 μm (such as 0.1-less than 30 μm, 1-less than 30 μm, 1-20 μm) are mixed together as the component (e); a big particle with a D₅₀ particle size of at least 10 μm (such as 10-200 μm, 10-150 μm) and a small particle with a D₅₀ particle size of less than 10 μm (such as 0.1-less than 10 μm, 1-less than 10 μm, 1-8 μm) are mixed together as the component (e).

Preferably, different types of the fillers are mixed together as the component (e), for example, (surface-treated) diamond and (surface-treated) aluminium nitride are mixed together as the component (e), (surface-treated) aluminium nitride and (surface-treated) aluminium oxide are mixed together as the component (e); (surface-treated) diamond, (surface-treated) aluminium oxide and (surface-treated) aluminium nitride are mixed together as the component (e).

The shape of the fillers useful in the present application is not particularly limited. They may have spherical, tetrahedral, hexahedral, octahedral, polyhedron, rod-like, needle-like, disk-like or irregular shape. In this description, the term “spherical” refers to a shape in which the entire surface is formed from a convex smooth surface. As for filler particles, the spheroidicity is, for example, 0.5 or higher, preferably 0.55 or higher and more preferably 0.6 or higher. The spheroidicity is an index indicating the degree close to a sphere. The spheroidicity of a sphere is 1. When the spheroidicity is high, such as in polyhedron shape, it increases the contact surfaces therefore easy for heat dissipating, and further when the spheroidicity is close to 1, it becomes easy for the filler particles to be dispersed in the silicone oil matrix. There is no particular limitation for the spheroidicity of the fillers.

Suitable commercially available examples of the fillers are SD-715, SD-715Q series, SD-720 and SD-720Q series from FoShan ZhanXun Material Co., Ltd; HFD-A, HFD-B and HFD-C from Henan Huifeng Diamond Co., Ltd, alumina particles from AN5, AN20 and AN30 from Suzhou Ginet New Material Technology Co., Ltd; AA04 from Sumitomo Chemical, NSM-1 and BAK-2 from Bestry Performance Materials Co., Ltd., DAM-03 from Denka Corporation.

In preferred embodiments, the thermally conductive filler is present in an amount of from 80% to 96% by weight, more preferably from 90% to 95% by weight, such as 81 wt %, 82, 83, 84, 85, 86, 87, 88, 89, 90, 91, 92, 93, 94, 95 wt %, or any ranges between two numbers listed above, based on the total weight of the composition.

In another preferred embodiments, the (surface-treated) diamond particle constitutes 0.01 to 90 wt % of the thermally conductive filler, based on total weight of the thermally conductive filler, such as 1 wt %, 5 wt %, 10, 15, 20, 25, 30, 35, 40, 45, 50, 55, 60, 65, 70, 75, 80, 85, 88 wt %, or any ranges between two numbers listed above, of the thermally conductive fillers.

### Component (f): Core-Shell Solid Polymer Particle

The core-shell solid polymer particles useful in the composition of the present application have a soft core and a hard shell, wherein the soft core is formed by a polymer having a Tg of less than 0° C., especially less than −20° C., (hereinafter abbreviated as core-polymer) and the hard shell is formed by a polymer having a Tg of no less than 0° C., especially no less than 20° C., (hereinafter abbreviated as shell-polymer).

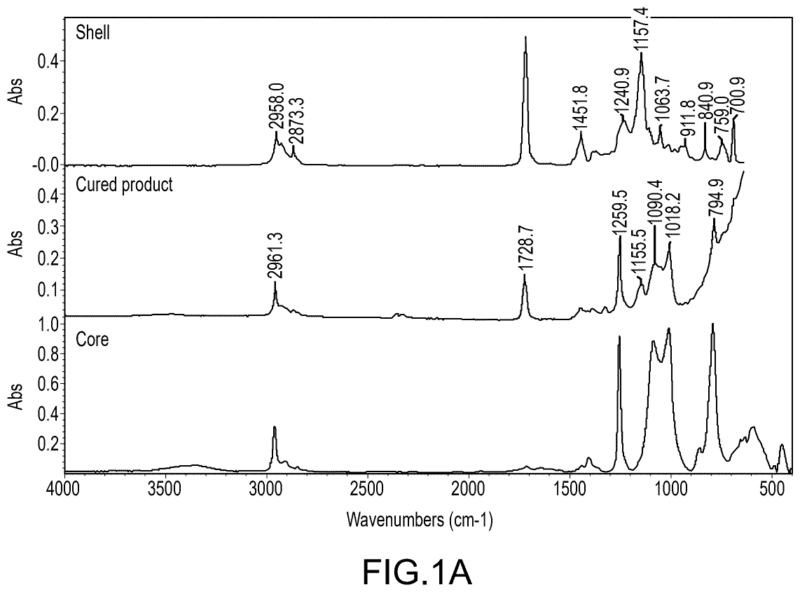

The core-shell solid polymer particle useful in the composition of the present application is in a solid state during the formulation and preparation of the gap pad and does not react with the silicone oil matrix. The FTIR spectrums (see FIGS. 1A to 1B) show that the core-shell polymer does not form a part of the cross-linked polymer, on the contrary, the chemical bonds in the core-shell polymer stays unchanged before and after the crosslinking, indicating that the core-shell solid polymer is physically mixed in the composition rather than crosslinks with the silicone oil. In FIG. 1A, the upper one is the FTIR spectrum of the shell-polymer of core-shell polymer particle M960 (which will be described later), the middle one is the FTIR spectrum of cured product with M960 contained therein (the formulation and cured product are substantially the same as Example 2 of the present application), and the lower one is the FTIR spectrum of the core-polymer of core-shell polymer particle M960. The FIG. 1B combines the FTIR spectrum of the shell-polymer and the FTIR spectrum of the cured silicone oils together. FIGS. 1A and 1B can demonstrate that the core-shell polymer particles are physically mixed with the silicone oils, but there might be slightly broken of the core-shell particle due to the mechanical mixing.

The Tg of the core-polymer or of the shell-polymer can be roughly calculated based on the monomers used for forming the polymer according to the FOX equation, and also can be determined using differential scanning calorimetry (DSC) based on the known method in the art.

$$1 / Tg = W 1 / Tg 1 + W 2 / Tg 2 + … Wn / Tgn \qquad ( FOX equation )$$

### Wherein:

Tg is the glass transition temperature of the polymer, ° C.
W1 is weight percentage of the first monomer, wt %
Tg1 is the Tg of the first monomer, ° C.
W2 is weight percentage of the second monomer, wt %
Tg2 is the Tg of the second monomer; ° C.
Wn is weight percentage of the nth monomer, wt %
Tgn is the Tg of the nth monomer, ° C.

The core-polymer of the present application can be a homopolymer or copolymer, as long as the Tg of the polymer satisfies the above limitation, that is, less than 0° C., such as less than −5° C., less than −10° C., less than −15° C., less than −20° C., less than −25° C., less than −30° C., less than −35° C., less than −40° C., less than −45° C., less than −50° C.

It is not necessary that all monomers of the core-polymer have a Tg of less than 0° C., as long as the obtained core-polymer has Tg of less than 0° C. It is preferred that all monomers of the core-polymer have a Tg of less than 0° C.

In preferred embodiments, the core-polymer may be a homopolymer or copolymer formed from monomers like dienes, alkyl (meth)acrylates, silicone rubbers, styrenics and mixtures thereof. Specific examples of the dienes monomer include, but not limited to, butadiene and isoprene. For example, the core-polymer can be a butadiene homopolymer, an isoprene homopolymer, a silicone rubber, a copolymer of butadiene or isoprene with one or more ethylenically unsaturated monomers (such as vinyl aromatic monomers, (meth)acrylonitrile, (meth)acrylates, or the like). Specific examples of alkyl (meth)acrylates include, but not limited to, methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, amyl (meth)acrylate, isoamyl (meth)acrylate, n-hexyl (meth)acrylate, cycloheyl (meth)acrylate, 2-ethylhexyl (meth)acrylate, pentadecyl (meth)acrylate, dodecyl (meth)acrylate, isobornyl (meth)acrylate, penyl (meth)acrylate, benzyl (meth)acryate, phenoxyethy (meth)acrylate, 2-hydroxyethyl (meth)acrylate and 2-methoxyethyl (meth)acrylate. Specific examples of styrenics include, but not limited to, alpha-methyl styrene and para-methyl styrene. In particular, the core-polymer can be a silicone rubber, Methyl methacrylate-Butadiene-Styrene (MBS) tripolymer, or alkyl acrylates polymer.

The shell-polymer of the present application can be a homopolymer or copolymer, as long as the Tg of the shell-polymer satisfies the above limitation, that is, no less than 0° C., such as no less than 5° C., no less than 10° C., no less than 15° C., no less than 20° C., no less than 25° C., no less than 30° C., no less than 35° C., no less than 40° C., no less than 45° C., no less than 50° C., no less than 80° C., no less than 100° C.

It is not necessary that all monomers of the shell-polymer have a Tg of no less than 0° C., as long as the obtained shell-polymer has Tg of no less than 0° C. It is preferred that all monomers of the core-polymer have a Tg of no less than 0° C.

In preferred embodiments, the shell-polymer may be a homopolymer or copolymer formed from monomers like methacrylates, acrylates, styrenics and mixtures thereof.

Specific examples of methacrylates for the shell-polymer include, but are not limited to, methyl methacrylate, ethyl methacrylate, n-propyl methacrylate, isopropyl methacrylate, n-butyl methacrylate, isobutyl methacrylate, sec-butyl methacrylate, tert-butyl methacrylate, amyl methacrylate, isoamyl methacrylate, n-hexyl methacrylate, cyclohexyl methacrylate, 2-ethylhexyl methacrylate, pentadecyl methacrylate, dodecyl methacrylate, isobornyl methacrylate, phenyl methacrylate, benzyl methacrylate, phenoxyethyl methacrylate, 2-hydroxyethyl methacrylate and 2-methoxyethyl methacrylate.

Specific examples of acrylates for the shell-polymer include, but are not limited to, methyl acrylate, ethyl acrylate, n-propyl acrylate, isopropyl acrylate, n-butyl acrylate, isobutyl acrylate, sec-butyl acrylate, tert-butyl acrylate, amyl acrylate, isoamyl acrylate, n-hexyl acrylate, cycloheyl acrylate, 2-ethylhexyl acrylate, pentadecyl acrylate, dodecyl acrylate, isobornyl acrylate, phenyl acrylate, benzyl acrylate, phenoxyethyl acrylate, 2-hydroxyethyl acrylate and 2-methoxyethyl acrylate. Preferably the acrylate ester monomers are chosen from methyl acrylate, ethyl acrylate, n-butyl acrylate, 2-ethylhexyl acrylate and octyl acrylate.

Specific examples of styrenics for the shell-polymer include, but are not limited to, styrene, and derivatives thereof such as, but not limited to, alpha-methyl styrene, and para-methyl styrene.

In particular, the shell-polymer comprises (or is) poly(methyl methacrylate) (PMMA).

The core constitutes 50-95 wt % of the core-shell particle, and the shell constitutes 5-50 wt % of the core-shell particle.

Preferably, the core-shell particles are relatively small in size. For example, the D₅₀ particle size may be from about 0.03 μm to about 5 μm or from about 0.05 μm to about 4 μm, or from 60 nm to 3 μm, or from 70 nm to 2 μm, or from 75 nm to 1 micron, such as 35 nm 40 nm, 55 nm, 65 nm, 80 nm, 90 nm, 1 μm, 1.2 μm, 1.4 μm, 1.6 μm, 1.8 μm, 2.0 μm, 2.2 μm, 2.4 μm, 2.6 μm, 2.8 μm, 3.0 μm, 3.2 μm, 3.4 μm, 3.6 μm, 3.8 μm, 4.0 μm, 4.2 μm, 4.4 μm, 4.6 μm and 4.8 μm, or any ranges between two numbers listed above. The term “D₅₀ particle size” means a median diameter in a volume-basis particle size distribution curve obtained by measurement with a laser diffraction particle size analyzer.

The core-shell polymer can be produced by any known technique, for example, by two-step emulsion or dispersion polymerization, for example, the core monomers are polymerized in aqueous dispersion or emulsion and then the shell monomers are polymerized onto the formed core-polymer.

The ratio in thickness of the soft core part and the hard shell part of the core-shell polymer particles used herein is not particularly limited, and the thickness ratio may be general one of the core part to the shell part formed in a usual manner by, for example, an emulsion polymerization method.

The commercially available core-shell solid polymer particles useful in the present application include, but not limited to, SX-005 from Mitsubishi Chemical Corporation, M500S from Shanghai Bangdi Mew Materials Co. Ltd., M960 from Anqiu Donghai Plastic Industry Co., Ltd, PARALOIDTM EXL-2300 and PARALOIDTM EXL-2330 from Dow Chemical.

Conventional tougheners or impact modifiers cannot be well mixed into the silicone oil matrix of the present application and usually form a mixture with separate phases, while the core-shell solid polymer particle mentioned above can be well blended into the silicone oil matrix and do not negatively affect the cross-linking of the silicone oils, and importantly, can impart resilience to the cured thermally conductive product. Meanwhile, only small amount of the core-shell solid polymer particle can greatly improve the resilience of the cured product.

According to the present application, the core-shell solid polymer particle can be contained in the composition in an amount of 0.01-1.0 wt %, preferably 0.02-0.9 wt %, such as 0.05, 0.08, 0.15, 0.20, 0.25, 0.30, 0.35, 0.40, 0.45, 0.50, 0.55, 0.60, 0.65, 0.70, 0.75, 0.80, 0.95 wt %, or any ranges between two numbers listed above, based on the total weight of the composition.

### Other Components

In addition to the above components a) to f), the composition of the present invention may optionally comprise other additives that are conventionally used in the art, for example, pigments, dyes such as fluorescent dyes, flame retardants, plasticizers, adhesion-imparting agents and combinations thereof, provided that the inclusion of these additives does not impair the object of the present invention, curing reaction inhibitor in particularly.

Further, the present application provides a method for preparing the thermally conductive gap pad with the composition of the present application. The preparation method includes mixing all components together, preferably with mixer, to form a uniform mixture, preferably subjecting to vacuum such as 0.05 Mpa to 0.5Mpa for such as 2-10 minutes to evacuate air bubbles, then allowing the mixture to cure. The above description for the composition all applies to the method of the present application.

The composition of the present invention has a good flowability with the thermally conductive filler loading of more than 80%, for example, having a flow rate more than 15 g/min, preferably more than 18 g/min, and more preferably more than 20 g/min defined as the adhesive composition weight dispensed under a pressure of 90 psi per minute using dispenser machine Nordson Ultimus-I equipped with a 30 cc plastic tube having a nozzle in a diameter of 2.54±5% mm. Such flow rate, especially more than 15 g/min ensures that the nozzle of conventional adhesive dispensers will not be blocked by the composition after mixing.

In preferred embodiments, the composition can be cured at room temperature for no more than 7 days. Curing can be accelerated by applying heat, for example, by heating from 60 to 200° C. (such as 70° C., 80° C., 100° C., 110° C., 120° C., 130° C., 140° C., 150° C., 160° C., 170° C., 180° C., 190° C.) for from 30 minutes to 2 hours.

In the present invention, the composition can be applied to the desired substrate by any convenient technique. It can be applied cold or be applied warm if desired. It can be applied by extruding or pasting it onto the substrate or other mechanical application methods such as a caulking gun. After application, the composition of the present invention is cured at room temperature, optionally followed by being curing at elevated temperature.

The composition of the present application can be made into gap pad for subsequent use. It is conceivable that the composition of the present application can be applied to any gap between two surfaces as an adhesive to bond the surfaces.

### EXAMPLES

The invention will now be described by way of the following examples. The following examples are intended to assist one skilled in the art to better understand and practice the present invention. The scope of the invention is not limited by the examples but is defined in the appended claims. All parts and percentages are based on weight unless otherwise stated.

### Thermal Conductivity (Tc):

The compositions were cured at 125° C. for 1 hour. The thermal conductivity of cured samples was tested under temperature of 80° C. and pressure of 40 psi by LW 9389 manufactured by Longwin according to ASTM-D5470.

### Resilience Rate

The compositions were cured at 125° C. for 1 hour. Applying 50% compression to the samples for 10 minutes, then releasing the force, and the resilience rate was recorded. The bigger the resilience rate is, the better the sample is.

### Examples 1 to 5 and Comparative Example 1 (EX. 1 to 5 and CE 1)

All components listed in Table 1 were mixed using a mixer under mixing speed of 1200 rpm for 10 minutes, vacuum was applied to evacuate the air bubbles under 0.1 Mpa for 5 minutes. The obtained mixture was cured under the temperature of 125° C. for 1 hour, cured products were obtained.

TABLE 1

| | CE1 | Ex1 | Ex2 | Ex3 | Ex4 | Ex5 |
|---|---|---|---|---|---|---|
| Silicone oil ¹⁾ | 5.7 | 5.4 | 5.2 | 6.5 | 6.5 | 6.5 |
| Silane Coupling agent ²⁾ | 0.27 | 0.27 | 0.27 | 0.27 | 0.27 | 0.27 |
| Catalyst ³⁾ | 0.01 | 0.01 | 0.01 | 0.01 | 0.01 | 0.01 |
| Inhibitor ⁴⁾ | 0.02 | 0.02 | 0.02 | 0.02 | 0.02 | 0.02 |
| Core-shell particle-1 ⁵⁾ | / | / | / | 0.3 | / | / |
| Core-shell particle-2 ⁶⁾ | / | / | / | / | 0.3 | / |
| Core-shell particle-3 ⁷⁾ | / | 0.3 | 0.5 | / | / | 0.3 |
| Diamond ⁸⁾ | 49 | 49 | 49 | 48.5 | 48.5 | 48.5 |
| Aluminium Nitride-1 ⁹⁾ | 15 | 15 | 15 | 13.9 | 13.9 | 13.9 |
| Aluminium Nitride-2 ¹⁰⁾ | 24 | 24 | 24 | 24.4 | 24.4 | 24.4 |
| Aluminium Nitride-3 ¹¹⁾ | 6 | 6 | 6 | 6.1 | 6.1 | 6.1 |
| Total | 100 | 100 | 100 | 100 | 100 | 100 |
| Resilience rate (%) | 17 | 35 | 50 | 26 | 34 | 45 |
| Tc (W/m · K) | 7 | 8 | 9 | / | / | / |

¹⁾ RH-Vi100E from Zhejiang Runhe Chemical New Material Co., Ltd, which is a vinyl-terminated alkyl silicone oil having viscosity of 85 to 115 m · Pas; and RH-H86 from Zhejiang Runhe Chemical New Material CO., Ltd, which is a methyl terminated hydrogen branched silicone oil. weight ratio of RH-Vi100E:RH-H86 is 2:1
²⁾ Methyltrimethoxysilane
³⁾ CATALYST 512, which is a divinyl tetramethyl disiloxane complex having 2% by weight of platinum, manufactured by Evonik
⁴⁾ Inhibitor MVC, which is a silicone-based inhibitor manufactured by Evonik.
⁵⁾ SX-005 from Mitsubishi Chemical Corporation, which is a core-shell solid polymer particle with silicone rubber forming the core and MMA forming the shell
⁶⁾ M500S from Shanghai Bangdi New Material Co., Ltd, which is a core-shell solid polymer particle with MBS forming the core and MMA forming the shell
⁷⁾ M960 from Anqiu Donghai Plastic Industry Co., Ltd, which a core-shell solid polymer particle with acrylic resin forming the core and MMA forming the shell
⁸⁾ surface-treated diamond with D50 particle size: 130 μm,
⁹⁾ D₅₀ particle size: 2 μm,
¹⁰⁾ D₅₀ particle size: 3 μm,
¹¹⁾ D₅₀ particle size: 30 μm

Comparing CE1 with Ex1 and Ex2, it can be seen that introducing the core-shell polymer particles greatly improved the resilience rate of the sample, and only small amount of the core-shell particle can make the improvement. Comparing CE1 and Ex1, 0.3 wt % of the amount of the silicone oil of CE1 was replaced with 0.3 wt % of the core-shell particle, the resilience rate was about doubled. In addition, the thermal conductivity was also slightly improved.

Comparing Ex3 to Ex5, it can be seen that the core-shell particles falling in the range of the present application significantly improved the resilience rate.

### Examples 6 to 7 and Comparative Example 2 to 3 (EX. 6 to 7 and CE 2 to 3)

All components listed in Table 2 were mixed using a mixer under mixing speed of 1200 rpm for 10 minutes, vacuum was applied to evacuate the air bubbles under 0.1 Mpa for 5 minutes. The obtained mixture was cured under the temperature of 125° C. for 1 hour, cured products were obtained.

TABLE 2

| | CE2 | Ex6 | CE3 | Ex7 |
|---|---|---|---|---|
| Silicone oil ¹⁾ | 5.53 | 5.00 | 5.31 | 4.82 |
| Silane Coupling agent ²⁾ | 0.25 | 0.25 | 0.25 | 0.25 |
| Catalyst ³⁾ | 0.01 | 0.01 | 0.01 | 0.01 |
| Inhibitor ⁴⁾ | 0.01 | 0.01 | 0.01 | 0.01 |
| Core-shell particle-3 ⁷⁾ | / | 0.53 | / | 0.49 |
| Aluminium Nitride-2 ¹⁰⁾ | 10.5 | 10.5 | / | / |
| Aluminium Oxide-2 ¹²⁾ | 17.4 | 17.4 | 43 | 43 |
| Aluminium Oxide-3 ¹³⁾ | 45.6 | 45.6 | 12.1 | 12.1 |
| Aluminium Oxide-1 ¹⁴⁾ | 20.7 | 20.7 | / | / |
| Aluminium Oxide-4 ¹⁵⁾ | / | / | 15.1 | 15.1 |
| Aluminium Oxide-5 ¹⁶⁾ | / | / | 24.22 | 24.22 |
| Total | 100 | 100 | 100 | 100 |
| Resilience rate (%) | 12 | 30 | 10 | 27 |
| Tc (W/m · K) | 4.5 | 4.9 | 4.2 | 4.8 |

^{1) to 4) and 7) and 10)} are the same as those in Table 1.
¹²⁾ D₅₀ particle size: 3 μm
¹³⁾ D₅₀ particle size: 120 μm,
¹⁴⁾ D₅₀ particle size: 5 μm
¹⁵⁾ D₅₀ particle size: 0.8 μm
¹⁶⁾ D₅₀ particle size: 4 μm

Comparing CE2 with Ex6 as well as CE3 with Ex7, it can be seen that the core-shell particle can improve the resilience rate no matter in what thermally conductive filler systems.

### Example 8 and Comparative Examples 4 (Ex 8 and CE 4)

All components listed in Table 3 were mixed using a mixer under mixing speed of 1200 rpm for 10 minutes, vacuum was applied to evacuate the air bubbles under 0.1 Mpa for 5 minutes. The obtained mixture was cured under the temperature of 125° C. for 1 hour, cured products were obtained.

TABLE 3

| | CE4 | Ex8 |
|---|---|---|
| Silicone oil ¹⁾ | 6.782 | 6.782 |
| Silane Coupling agent ²⁾ | 0.023 | 0.023 |
| Catalyst ³⁾ | 0.01 | 0.01 |
| Inhibitor ⁴⁾ | 0.005 | 0.05 |
| Core-shell particle-2 ⁶⁾ | / | 0.58 |
| Polyether ester elastomer ¹⁷⁾ | 0.58 | / |
| Aluminium Oxide-7 ¹⁸⁾ | 23 | 23 |
| Aluminium Oxide-8 ¹⁹⁾ | 51.8 | 51.8 |
| Aluminium Oxide-9 ²⁰⁾ | 17.8 | 17.8 |
| Total | 100 | 100 |
| Resilience rate (%) | 12 | 47 |

^{1) to 4) and 6)} are the same as those in Table 1 and Table 2.
¹⁷⁾ Hytrel ® 3078 available from Dupont, which is a conventional non-core-shell toughener
¹⁸⁾ D₅₀ particle size: 1 μm
¹⁹⁾ D₅₀ particle size: 45 μm
²⁰⁾ D₅₀ particle size: 10 μm

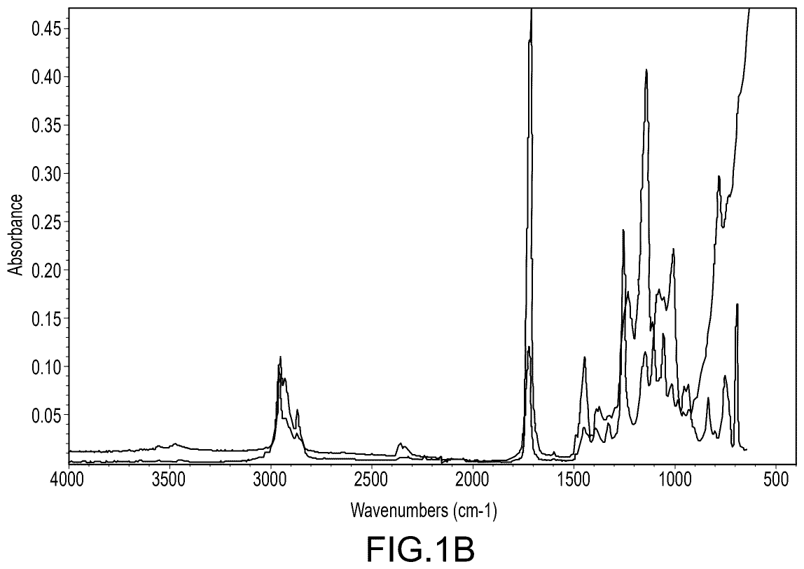

In FIG. 2, the left pictures show the composition containing the polyether ester elastomer Hytrel® 3078, and the right pictures show the composition containing the core-shell particle M500S. It can be seen from FIG. 2 that the Hytrel® 3078 cannot be well blended into the silicone oil matrix and there are visible agglomerates in the silicone oil matrix.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A composition for a high-resilient thermally conductive gap pad, comprising:
(a) a reactive silicone oil,
(b) a silane coupling agent,
(c) a catalyst,
(d) optionally, an inhibitor,
(e) a thermal conductive filler, and
(f) a core-shell solid polymer particle, wherein the core-shell solid polymer particle has a soft core formed by a polymer having a Tg of less than 0° C. and a hard shell formed by a polymer having a Tg of no less than 0° C.

2. The composition according to claim 1, wherein
the soft core is formed by a polymer having a Tg of less than −20° C., and/or
the hard shell is formed by a polymer having a Tg of no less than 20° C.

3. The composition according to claim 1, wherein
the polymer of the soft core is a homopolymer or copolymer formed from monomers selected from dienes, alkyl (meth)acrylates, silicone rubbers, styrenics and mixtures thereof, and/or
the polymer of the hard shell is a homopolymer or copolymer formed from monomers selected from methacrylates, acrylates, styrenics and mixtures thereof.

4. The composition according to claim 1, wherein the core-shell solid polymer particle (f) is present in an amount of 0.01-1.0 wt %, based on the total weight of the composition.

5. The composition according to claim 1, wherein the core-shell solid polymer particle (f) has a D₅₀ particle size of from 0.03 μm to 5 μm or from 0.05 μm to 4 μm.

6. The composition according to claim 1, wherein based on the total weight of the composition,
the reactive silicone oil (a) is present in an amount of 1.0-7.0 wt %, and/or
the silane coupling agent (b) is present in an amount of 0.1-5.0 wt %, and/or
the catalyst (c) is present in an amount of 0.001-0.05 wt %, and/or
the inhibitor (d) is present in an amount of 0.0001-1.0 wt %, and/or
the thermally conductive filler (e) is present in an amount of 80-96 wt %, and/or
the core-shell solid polymer particle (f) is present in an amount of 0.02-0.9 wt %.

7. The composition according to claim 1, wherein the reactive silicone oil comprises a terminal group (R)₃SiO_{1/2} (M unit) and at least one middle group selected from (R)₂SiO_{2/2} (D unit), RSiO_{3/2} (T unit) and SiO_{4/2} (Q unit), in which R, independently from each other, represents a mono-valent hydrocarbon group having 1 to 40 carbon atoms, with the proviso that at least one of the M unit, D unit and T unit comprises a reactive group selected from —SiH group and an alkenyl group.

8. The composition according to claim 1, wherein the reactive silicone oil comprises or consists of a mixture of an alkenyl-containing silicone oil and a SiH-containing silicone oil, or a mixture of different alkenyl-containing silicone oils, or a mixture of different SiH-containing silicone oils.

9. The composition according to claim 1, wherein the silane coupling agent is selected from 3-methacryloxypropyltrimethoxysilane, methyltrimethoxysilane, 3-glycidoxypropyltrimethoxysilane, tetraethoxysilane, vinyltriethoxysilane, methyltris(methylethylketoxime)silane, vinyltriacetoxysilane, and ethyl orthosilicate.

10. The composition according to claim 1, wherein the inhibitor is selected from an alkynol, a hydrazine-based compound; a phosphine-based compound; multi-vinylpolysiloxanes or a mercaptan-based compound.

11. The composition according to claim 1, wherein based on the total weight of the composition,
the reactive silicone oil (a) is present in an amount of 2.0-6.8 wt %, and/or
the silane coupling agent (b) is present in an amount of 0.1-3.0 wt %, and/or
the catalyst (c) is present in an amount of 0.002-0.03 wt %, and/or
the inhibitor (d) is present in an amount of 0.001-0.5 wt %, and/or
the thermally conductive filler (e) is present in an amount of 90-95 wt %.

12. The composition according to claim 11, wherein the thermally conductive filler (e) is selected from diamond particles, alumina particles, aluminium nitride particles, fumed silica, precipitated silica, fumed titanium oxide and combinations thereof.

13. The composition according to claim 12, wherein the thermally conductive filler (e) comprises different types of fillers and/or different sizes of fillers.

14. The composition according to claim 12, wherein the diamond particles constitute 0.01 to 90 wt % of the thermally conductive filler, based on total weight of the thermally conductive filler.

15. The composition according to claim 12, wherein the diamond particles constitute 30 to 60 wt % of the thermally conductive filler, based on total weight of the thermally conductive filler.

16. A thermally conductive gap pad made from the composition according to claim 1.

17. A method for preparing a thermally conductive gap pad, comprising.
(i) mixing the following components (a) to (f) to form a mixture:
(a) a reactive silicone oil,
(b) a silane coupling agent,
(c) a catalyst,
(d) optionally, an inhibitor,
(e) a thermal conductive filler, and
(f) a core-shell solid polymer particle, wherein the core-shell solid polymer particle has a soft core formed by a polymer having a Tg of less than 0° C. and a hard shell formed by a polymer having a Tg of no less than 0° C.,
(ii) allowing the mixture to cure.

18. The method according to claim 17, wherein the cure is conducted at room temperature or at elevated temperature in a range of 60-200° C.

19. The method according to claim 17, wherein based on the total weight of the composition,
the reactive silicone oil (a) is present in an amount of 1.0-7.0 wt %, and/or
the silane coupling agent (b) is present in an amount of 0.1-5.0 wt %, and/or
the catalyst (c) is present in an amount of 0.001-0.05 wt %, and/or
the inhibitor (d) is present in an amount of 0.0001-1.0 wt %, and/or
the thermally conductive filler (e) is present in an amount of 80-96 wt %, and/or
the core-shell solid polymer particle (f) is present in an amount of 0.02-0.9 wt %.

20. An article comprising the thermally conductive gap pad made from the composition according to claim 1.
